(19) United States
(12) Patent Application Publication
(10) Pub. No.: US 2003/0076350 A1
(43) Pub. Date: Apr. 24, 2003

(54) Interface for content development

(75) Inventor: Giao Vu, Sacramento, CA (US)

Correspondence Address: Mr. Charanjit Brahma, PILLSBURY WINTHROP LLP, Suite 2800, 725 South Figueroa Street, Los Angeles, CA, 90017, US

(73) Assignee: Toshiba America Information Systems, Inc

(21) Appl. No.: 10/001,321

(22) Filed: Oct. 23, 2001

(51) Int. Cl. G09G 5/00

(52) U.S. Cl. 345/738; 345/762; 345/764

(57) ABSTRACT

Embodiments of the present invention are generally directed to a system and method for developing content using a graphical user interface that allows a developer to view a preview image during the development process. The content may be developed according to a content format that is associated with one or more content features, such as, product images, product description text, pricing information text, availability information text, and the like. In particular embodiments, the graphical user interface may have a development pane in which the developer selects from existing content pieces or enters new content pieces to associate with content features. As the content pieces are associated with the content features for the selected content format, the content pieces may be displayed in the preview image, which may appear in a separate preview pane.

### BACKGROUND

In developing dynamic visual content to be displayed, for example, when a user terminal accesses a web site, web site developers are often asked to merge data into a standardized display format. As an example, in a product advertisement context, the data may include filename or locations associated with product images, pricing information, feature information, product categorization, and the like. Traditional tools for developing visual content generally require the developer to enter data in a database format.

In many cases, however, the amount of data that must be entered becomes unwieldy, making it difficult for the developer to ensure accuracy in the data entry process. Furthermore, entry of data into a database does not easily allow a developer to verify the correctness of the data entered. Moreover, in many cases, only a subset of the database information must be accessed for a particular application. Therefore, only a subset of the information required by the database would actually need to be entered by the developer in these cases and the effort required to enter the unused information is wasted.

In other systems for the development of print advertising using the Internet (e.g., U.S. Pat. No. 6,167,382), users have been required to select an advertising template and then select images and text strings from fixed sets thereof to display within the format of the template. This type of system still relies upon the tedious development of a database encompassing the various product advertisement templates and the sets of images and text strings that may be incorporated therewith. Furthermore, with this type of system, it is difficult to change the format of an advertisement without starting from scratch.

### BRIEF DESCRIPTION OF THE DRAWINGS

FIG. 1 shows a screenprint of a portion of the development pane of an interface according to an embodiment of the present invention prior to the developer's entering data to be incorporated in the content;

FIG. 1A shows a screenprint of the portion of the development pane of the interface according to an embodiment of the present invention after the developer has entered data to be incorporated in the content;

FIG. 2 shows a screenprint of the preview pane portion of the interface according to an embodiment of the present invention prior to the developer's entering data to be incorporated in the content;

FIG. 2A shows a screenprint of the preview pane portion of the interface according to the embodiment shown in FIG. 1 after the developer has entered data to be incorporated in the content;

FIG. 3 illustrates an exemplary content piece database record that may be used according to an embodiment of the present invention;

FIG. 4 illustrates an exemplary format database record that may be used according to an embodiment of the present invention; and

FIG. 5 depicts a communication network and computer system that may be used according to an embodiment of the present invention.

### DETAILED DESCRIPTION

The present invention is generally directed to a graphical user interface and associated system that may be used by developers for the development of content as well as the method of using such a system. According to embodiments of the present invention, a graphical user interface may prompt the developer to enter data in required fields in a development pane. The interface may display a “preview” version of the content in a preview pane, allowing the developer to easily determine whether the correct data has been entered. The data fields presented to the developer in the development pane and the preview image displayed in the preview pane may depend upon a content format chosen by the developer.

The discussion below will further describe the features and use of embodiments of the interface in the context of developing product advertising content. However, a person of ordinary skill in the art will readily understand that the systems and methods described herein may be applied in the development of any type of content involving data entry or the selection of data from a data storage structure (e.g., a database).

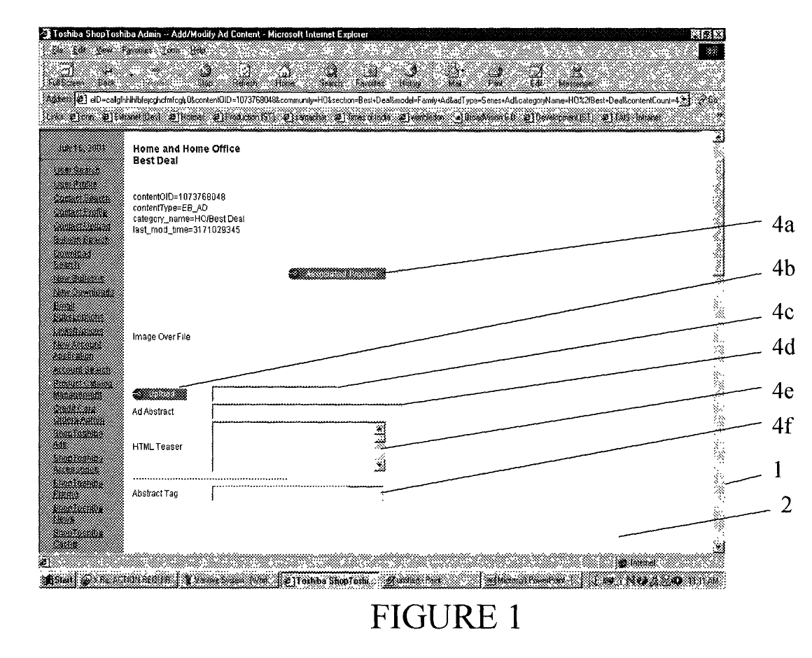

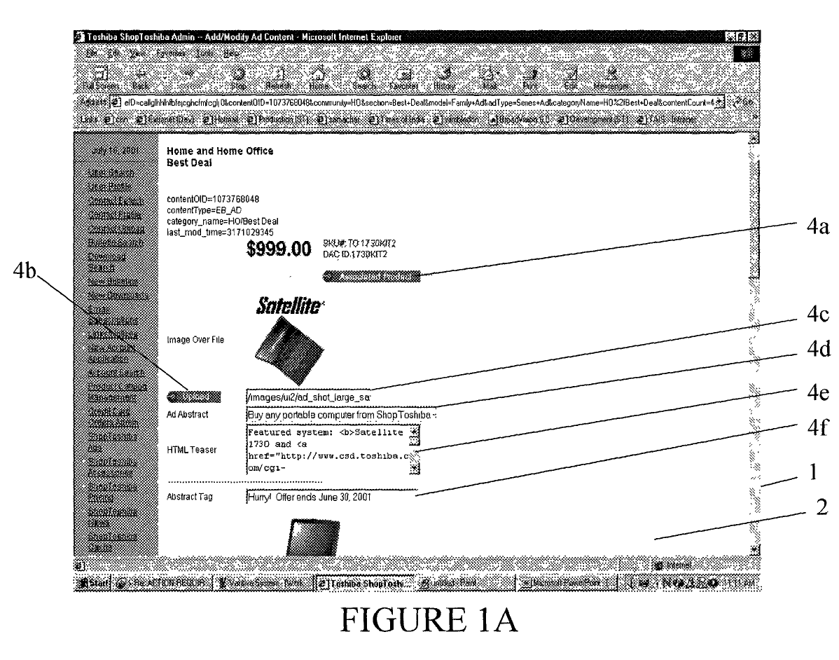

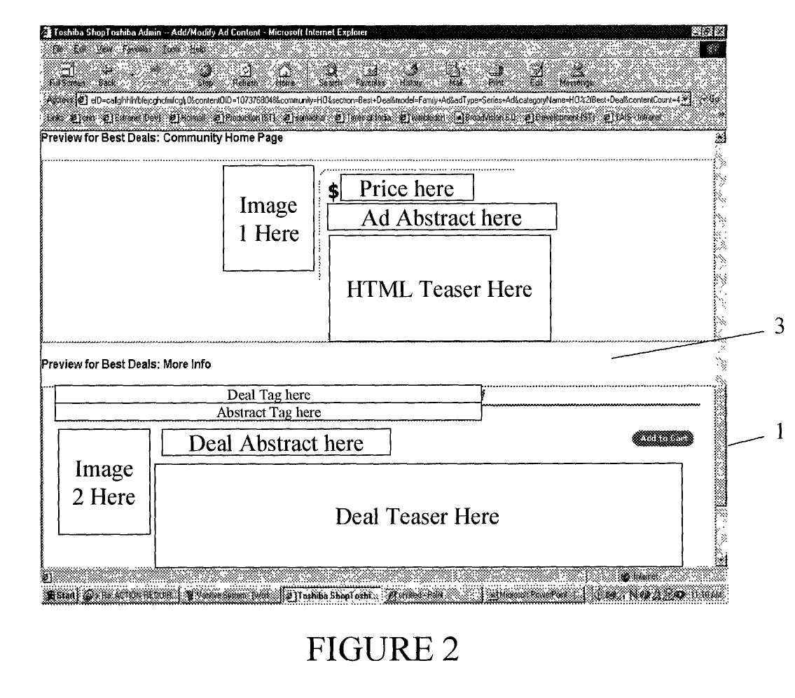

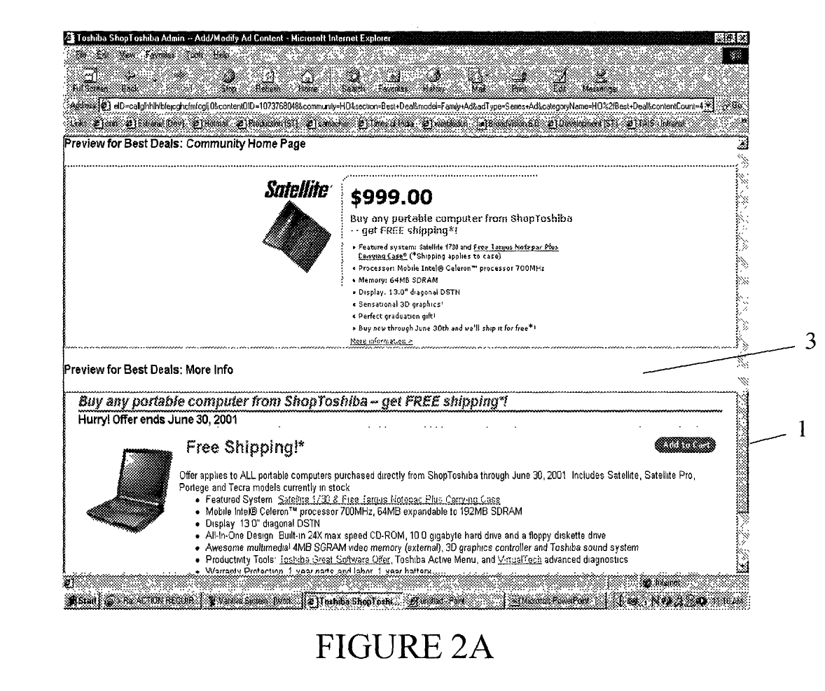

FIGS. 1, 1A, 2 and 2A show screenprints of portions of the interface 1 as it may be displayed to the developer according to an embodiment of the present invention. FIG. 1 shows part of a development pane portion of the interface 1 before data has been entered by the user. FIG. 1A shows the same development pane portion of the interface 1 after data has been entered by the user. FIGS. 2 and 2A show a preview pane portion of the interface 1 before and after data has been entered by the user. The displayed interface 1 may include a development pane 2 and a preview pane 3. The preview pane 3 may display the content, e.g., a product advertisement, in the form it would appear if no additional data were entered (a “preview image”) in the development pane 2. The preview image displayed in the preview pane 3 may be scaled to fit within the borders of the preview pane 3 during development.

The preview image displayed in the preview pane 3 may include various content features, such as color or black-and-white graphical images, background fields (patterns, watermarks, etc.), text strings, video clips, animation, dynamic features (e.g., links to other Web pages or selectable icons), and the like. Each type of content feature may have associated characteristics that a developer can manipulate. For example, a content developer may associate a text string with fonts, colors, character spacing settings, bolding, underlining, italicization, and the like. Content pieces that may be associated with these content features may be stored in a data storage structure, such as a database.

According to an embodiment of the invention shown in FIGS. 1, 1A, 2 and 2A, a user may decide to develop content of a particular known format and may select the desired format from a list of available formats. Alternatively, the format may be determined by the use for which the content is intended. For example, in a product advertisement context, if the content is to be displayed on a particular Web page in a Web site that is used to display the “Product of the Week”, a format associated with content displayed on that page may be automatically selected or may be provided as a default.

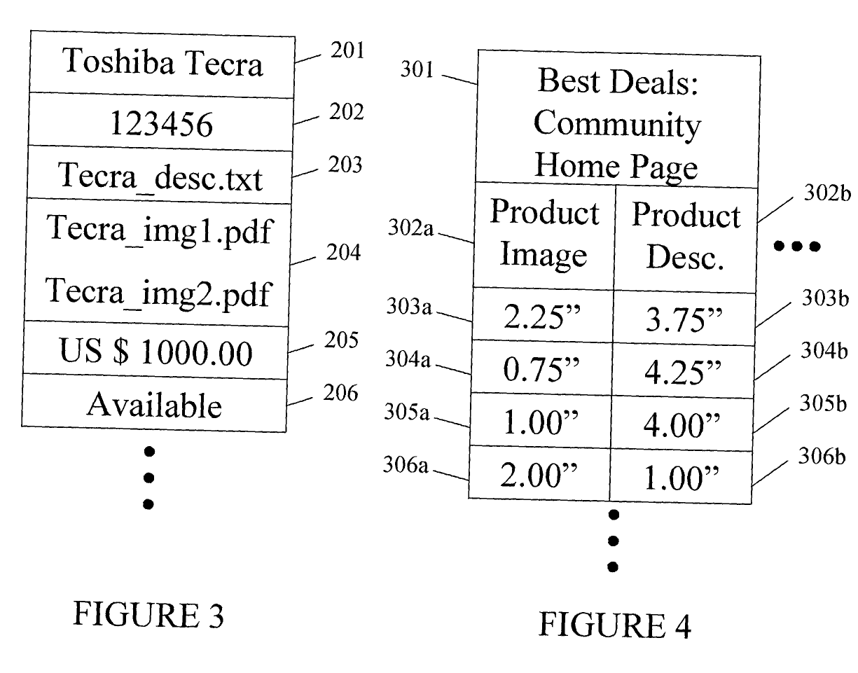

The development pane 2 may include several data input tools 4a-4f, which may be in the form of pull-down menus, selectable icons, text bars, and the like or combinations thereof. The data input tools 4a-4f may be associated with various content features associated with the selected format. In alternative embodiments, the development pane 2 may have data input tools 4a-4f that are associated with all possible content features, even those that are not associated with a selected format. The data input tools 4a-4f may list available content pieces to populate a content feature. For example, the data input tool 4a associated with the product identification feature may list product names that identify records stored in a content piece database (as more fully described with respect to FIG. 3). Similarly, the data input tools 4b and 4c associated with a product image feature may list product image files available to be associated with the product image feature through a pull-down menu, selectable icons, a text box or a similar input mechanism.

According to the embodiment shown, the data input tools 4a-4f may be used to associate image and text content with content features. However, in alternative embodiments of the invention, data input tools may also be provided for associating audio content, animation content and the like with various content features. The data input tools 4a-4f may allow the developer to create a new content option, or to associate a stored content option with the content feature. When a developer enters data for new content options, the entered data may be stored in an appropriate record or location in a content data storage structure(s). Thus, a developer may choose a new product image file for display in the product image area 5 of the preview pane 1 by entering a filename or memory address location at which the desired product image file may be found. The entered filename or memory address may be added to the record associated with that product in the content piece database (e.g., in the product image element 204 as shown in FIG. 3).

The available selections for each data input tool 4a-4f may depend upon content selected or data entered in the other data input tools 4a-4f. For example, selection of the SKU number for a “Toshiba Satellite” portable computer in the data input tool 4a associated with the product identification feature may determine what image files are listed as available when the user selects data input tool 4b, because the record associated with the SKU number may contain or refer to a specific set of image content pieces.

Both the development pane 2 and the preview pane 3 may be divided into multiple areas, each of which is associated with a different content format. For example, as shown in FIGS. 1, 1A, 2 and 2A, the development pane 2 and the preview pane may include areas for content in the “Best Deals: Community Home Page” format and in the “Best Deals: More Info” format. Alternatively, a data input tool may be used to designate the format of the content being designed by the user. The format selected in a data input tool associated with the content format may determine the number, type and configuration of the other data input tools 4a-4f.

In embodiments of the invention, the developer may associate a data input tool 4a-4f with a content feature by selecting the feature in the preview image. The selection may be made, for example, by positioning a pointer over an area of the preview image corresponding to the content feature and selecting the content feature by sending an input signal (e.g., by depressing and releasing a mouse button while the pointer is located within the area) to the graphical user interface. Changing the content feature with which the data input tool 4a-4f is associated may change the content pieces displayed by the data input tool 4a-4f, the data storage structure elements accessed by the data input tool 4a-4f, and the like.

The preview pane 3 may show the content as it will appear given the current data input/data selections provided by the developer, i.e., as the content would appear at the current stage of development. The preview image may indicate that a content piece has not been entered or selected for a particular content feature associated with a selected format. For example, as shown in FIG. 1, before a product image has been selected or entered by the developer, the preview pane 3 may display the text “No product image selected” in the area of the preview image associated with the product image, i.e., product image area 5. When the developer selects a product image to be displayed with the content, the preview image may be modified to show the selected product image in the product image area 5.

The preview image may also associate feature manipulation tools with the content features displayed therein. For example, as displayed, content features may be associated with sizing and positioning handles that allow a developer to move or resize a content feature by positioning a pointer over the content feature or its associated handles, clicking a mouse button (or submitting other input) to select the content feature or its associated handles, and dragging the feature or handle to another location (or releasing the mouse button once the feature or handle has been selected and clicking on another location).

An example of a content piece database record that may be associated with product advertisement content is shown in FIG. 3. In various embodiments of the invention, the type, number and order of records may be different. According to an embodiment of the invention, a database record storing content piece elements may include a product name element 201, a product identifier element 202, a product description element 203, a product image element 204, a product price element 205, and a product availability element 206. As shown, the product name element 201 includes the text string “Toshiba Tecra,” the name of a popular notebook computer product manufactured by Toshiba Corporation. This product may be associated with an identification code, such as a SKU number, shown as the text string “123456” in product identifier element 202. In alternative embodiments, the product may be associated with a non-text identification code, such as a barcode image. In such an embodiment, the product identifier element 202 may store a filename or memory address location from which the identification code may be retrieved.

In the embodiment of the invention shown in FIG. 3, the product description element 203 may contain a filename(s) or memory address(es) at which a text string describing the product may be found. The text string may convey information about product features. For example, if the content to be displayed is an advertisement for the Toshiba Tecra, the product description text may include information about the CPU clock speed, available random-access memory (RAM) or read-only memory (ROM), and the like. For each product, various product description files may be stored that highlight different features of the product. For example, for the Toshiba Tecra product, one description file may highlight product features that would be of interest to the basic consumer, while a second description file may highlight features of particular importance to consumers who travel frequently, e.g., battery life, communication features such as an internal modem, etc., or consumers who perform graphics-intensive functions, e.g., graphics cards, monitor size, accelerator chips, etc.

In embodiments of the invention, for text content pieces, text files may associate the contained text with formatting characteristics such as font, pitch, color, darkness (bolding), character spacing, underlining, italicizing, and the like. Similarly, for image content pieces, image files may associate an image with formatting characteristics such as brightness, contrast, orientation, and the like. Animation and video clip content pieces may be associated with formatting characteristics such as frame speed, orientation, etc. in such content files as well. Alternatively, these formatting characteristics may be associated with the content piece when the content is incorporated into a particular content format. For example, a selected content format may automatically ascribe a particular font, pitch and color to a pricing text content piece and a different font, pitch and color to a descriptive text content piece. In other embodiments of the invention, such formatting characteristics may be associated with a content piece by the developer using the development pane 2.

In embodiments in which the product description element 203 contains multiple filenames or memory addresses, the user may be prompted to select a particular file or memory address to be accessed during the development of the content using the development pane 2. Available content options may be displayed through a pull-down menu, multiple selectable icons, or the like.

Product image element 204 may contain a filename(s) or memory address at which an image of a product may be found. The image file may be in MPEG, JPEG, GIF, PDF, bitmap or some other format. The image contained therein may be scalable to fit within a display area designated by the selected content format. As with the product description element 203, the product image element 204 may contain multiple filenames or memory addresses (as shown) associated with multiple image files showing the product from different perspectives or showing different versions of the product.

Product price element 205 may contain a text string reflecting a price to be charged for the product. In alternative embodiments of the invention, the product price element may contain information about pricing in various currencies, rebate offers, volume discounts, and the like. The product price element may alternatively contain a filename or memory address at which a file containing such information may be retrieved. In embodiments of the invention, the product price element 205 may contain a numerical product price in a baseline currency and this number may be manipulated to provide display content of a product's price in different currencies.

Product availability element 206 may contain a text string indicating whether the product is currently available or, if not, when the product may be expected to become available. For example, for a product that has not yet been introduced, the element may contain launch date information. In an alternative embodiment, the product availability element 206 may contain a number of units of the product currently available. As with many of the other elements, in alternative embodiments, the product availability element 206 may contain a filename or memory address at which a text, image or other file containing such information may be found.

Although the foregoing discussion describes the content piece database as a single data storage entity, in embodiments of the invention, content piece elements may be distributed across multiple different data storage structures. For example, in embodiments of the invention, product availability element 206 may be part of a larger inventory tracking database and product price element 205 may be part of a pricing database that incorporates vendor data, currency conversion rates and the like.

FIG. 4 illustrates an exemplary format database record that may be used according to an embodiment of the present invention. The format database may be three-dimensional and may store information regarding a number of different possible content formats. The format database may include records corresponding to various formats available to the developer. In the exemplary record shown in FIG. 4, the record may include a format identification element 301 indicating an identifier for the available format. The record may also include feature identification elements 302a and 302b, feature position elements 303a-303b and 304a-304b and feature size elements 305a and 305b.

Feature identification elements 302a and 302b may identify content features associated with the format. The information contained in feature identification elements 302a and 302b may correspond to content piece database record elements. For example, as shown in FIG. 4, feature identification element 302a may point to the product image element 203 of a content piece database record corresponding to a product selected by the developer in the development pane 2. A format record may associate multiple content features of the same type with a particular format. For example, a standard product advertisement format may be associated with distinct text features for product description, price, and availability information.

For a particular content feature associated with the format, feature position elements 303a-303b and 304a-304b may indicate the position of the content feature. In embodiments of the invention, the position may be given in two dimensions by specifying a height and width measurement of a point in the displayed image of the content feature relative to a point in the entire content image, preview image, display area, or the like. In other embodiments of the invention, the location of the content feature may be specified in a single dimension or in more than two dimensions. For example, the location of a content feature may be specified in three dimensions and may indicate that a particular feature is within a particular layer of the displayed content image, which may be obscured by other layers. Accordingly, in embodiments of the invention, a format database record may include more or fewer feature position elements than are shown in FIG. 4. In embodiments of the invention, the number of feature position elements 303a-303b and 304a-304b may not correspond with the number of dimensions in which a content feature's position is specified. For example, in embodiments of the invention, each position in a content image, preview image or the like may be designated by a unique number or other identifier. In such embodiments, a single feature location element containing the unique number or identifier corresponding to the position at which the content feature is to be located may suffice.

The feature position elements 303a-303b and 304a-304b may describe the position of the centerpoint of the feature, the position of a point on the boundary of the feature (e.g., a comer), or any other point related to the content feature or content pieces that may be used to populate the content feature. The point in the content piece to be used for positioning may be specified in the content piece database record associated with the product.

The location of a content feature may be specified in absolute or normalized terms. For example, the centerpoint of the content feature may be described as “0.5” in both height and width to indicate that the centerpoint of the content feature coincides with the centerpoint of the content image (midpoint of both height and width). This may be preferred in embodiments in which the content feature must be scaled to fit different display areas, e.g., the preview pane when displayed as part of a preview image and the display area when displayed as part of developed content.

Feature size elements 305a-305b and 306a-306b may specify the size of the area in which the content feature is to be displayed. As with the feature location elements 303a-303b and 304a-304b, size information may be given in absolute or normalized measurements, particularly in embodiments in which the feature size is scaled to accommodate different content image, preview image or other image sizes. Furthermore, where the feature size attributed to a content feature is smaller than a content piece associated with the content feature, the content piece may be cropped or scaled to fit within the area of the preview image or content image in which the content feature is displayed.

In embodiments of the invention, a format database record may also include feature characteristic elements prescribing particular feature characteristics to content features associated with a particular format. For example, feature characteristic elements may ascribe a font, color and pitch to a text content feature.

Referring back to FIGS. 1 and 2, in alternative embodiments of the invention, the interface 1 may have a single combined pane in which the preview image is displayed and regions of the displayed preview image may be selected for manipulation. For example, when a developer has not yet selected or entered content data to populate a content feature, the area of the preview image associated with the content feature may display a text message requesting an appropriate input or selection as well as a data input tool. When a selection has been made or data has been entered, the selected or entered content may be displayed in that portion of the preview image. If the developer wishes to change the selected or entered content for a content feature, the developer may enter an input (e.g., a mouse button click when the mouse pointer is over the portion of the preview image associated with the content feature), the preview image may again display the data input tool. In such an embodiment, the preview image may be the same size as the developed content image, since a portion of the display area need not be dedicated to a development pane 2.

Furthermore, while the above-described embodiments of the invention have focused on graphical content, audio content may also be included. In embodiments of the invention, audio content may be associated with other content in the content piece database. Audio content elements may contain filenames or memory address locations at which audio files may be located. Audio files may be in MP3, MIDI, or some other suitable format. The audio files may associate audio content with formatting characteristics, such as play speed. Alternatively, this may be done automatically based on a format selected by the developer or may be done by the developer using the development pane 2. Audio content may be “displayed” in the preview image either by playing the audio content or by displaying a selectable icon whose selection causes the audio content to be played.

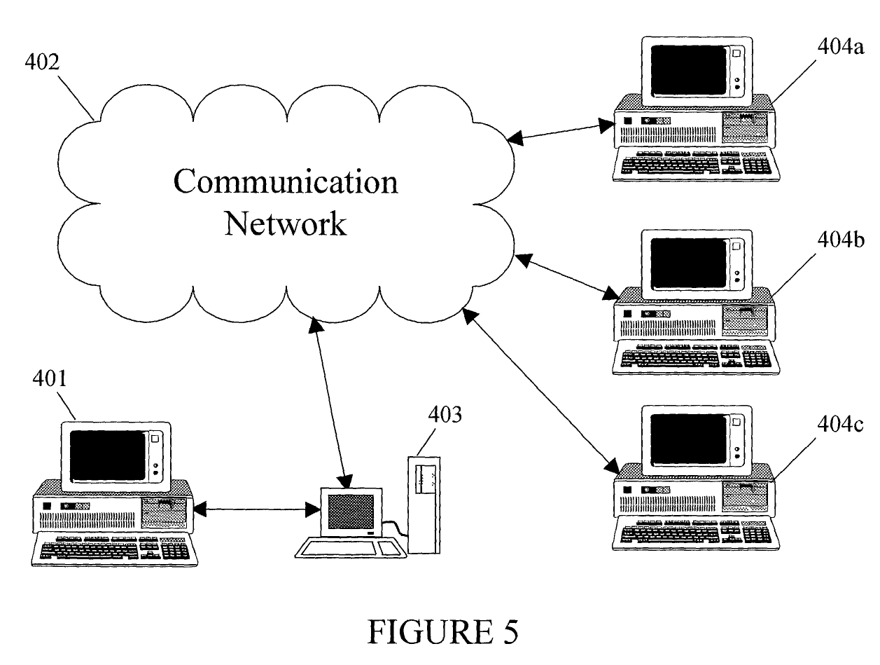

FIG. 5 depicts a communication network and computer system that may be used according to an embodiment of the present invention. A developer using a developer terminal 401 may update content stored in a central computer 403 (e.g., a server). Content stored on central computer 403 may be transmitted to user terminals 404a-404c via a communication network 402, such as the Internet, a local area network (LAN), wide area network (WAN) or metropolitan area network (MAN). The central computer 403 may also receive instructions from the user terminals 404a-404c indicating what content a user wishes to access. As shown in FIG. 5, the developer terminal 401 may be directly communicatively connected to the central computer 403. The communication system shown may use any network implementation, including, for example, the Ethernet, ARCnet, and Token Ring implementations. Information communicated over the communication connections may conform to any data communications protocol, including TCP/IP, IPX/SPX, NetBios and AppleTalk. Communication connections may consist of a wire line (such as twisted-pair telephone wire, coaxial cable, electric power line, optical fiber wire, leased line or the like) or wireless (such as satellite, cellular, radio frequency or the like) connection.

In an embodiment of the invention, content and format data storage structures may reside in a portion of a memory associated with the central computer 403 and access to these data storage structures may be limited to the developer terminal 401. Developed content may be stored in a separate portion of a memory associated with the central computer 403 or in a different memory associated with the central computer 403. Both user terminals 404a-404c and the developer terminal 401 may be given access to the developed content. A hardware or software firewall may be used to prevent user terminal 404a-404c access to the content and format databases.

Although many of the above-mentioned embodiments of the invention have focused on the development of content for display in an electronic medium, the present invention is also directed to the development of content for display in a print medium. For example, in a product advertising context, embodiments of the present invention may be used to rapidly develop numerous versions of a product catalog or print advertisements appearing in newspapers, magazines and other print media. In such embodiments, the developer terminal 401, central computer 403, or user terminals 404a-404c may transmit developed content to a printing device for production of hard copies.

While the description above refers to particular embodiments of the present invention, it should be readily apparent to people of ordinary skill in the art that a number of modifications may be made without departing from the spirit thereof. The accompanying claims are intended to cover such modifications as would fall within the true spirit and scope of the invention. The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

What is claimed is:

1. A system for aiding in the development of displayed content, said system comprising:
a user terminal having a first display device;
a central computer;
a communication network, said central computer communicatively connected to said user terminal via said communication network, such that said central computer may cause content to be displayed by said first display device;
a computer readable medium communicatively connected to said central computer, said computer readable medium encoded with content information and content format information; and
a developer terminal having a second display device, said developer terminal communicatively connected to said central computer such that said developer terminal may access said content information and said content format information,
wherein said second display device is configured to display a user interface having:
a data input tool corresponding to a content feature; and
a preview image corresponding to an image of said content as it would appear at a current stage of development, said preview image having an area corresponding to said content feature,
wherein said data input tool is configured to associate a content piece with said content feature, and
wherein said area of said preview image indicates whether said content piece has been associated with said content feature.

2. The system according to claim 1, wherein said content piece is one of a text string, a text file, an image, an image file, a video clip, an animated clip and an audio clip.

3. The system according to claim 1, wherein said data input tool is one of a pull-down menu, a text bar, and a selectable icon.

4. The system according to claim 1, wherein said user interface is configured to retrieve said content piece from a computer readable medium encoded with a plurality of content pieces.

5. The system according to claim 4, wherein said plurality of content pieces are organized into groups in a data storage structure.

6. The system according to claim 4, wherein said data storage structure is a database and said groups are database records.

7. The system according to claim 1, said data input tool further configured to display an available content piece that a developer can selectively associate with said content feature.

8. The system according to claim 1, said preview image further including a feature manipulation tool associated with said content feature, said feature manipulation tool configured to allow said developer to change at least one of a size and a location of said content feature.

9. The system according to claim 1, wherein said preview image is configured to display said content piece in said area corresponding to said content feature after said content piece has been associated with said content feature by said developer.

10. The system according to claim 1, wherein said data input tool is configured to accept a new content piece entered by said developer.

11. The system according to claim 10, wherein said user interface is configured to store said new content piece in a computer readable medium encoded with a plurality of content pieces.

12. The system according to claim 1, wherein said developer associates said data input tool with said content feature by selecting said area of said preview image.

13. The system according to claim 1, wherein said data input tool is displayed within a development pane and said preview image is displayed within a preview pane.

14. The system according to claim 1, wherein said data input tool is displayed in a portion of said preview image.

15. The system according to claim 1, wherein said area of said preview image indicates whether said content piece has been associated with said content feature by displaying said content piece when said content piece has been associated with said content feature and displaying a data input tool when said content piece has not been associated with said content feature.

16. The system according to claim 1, wherein said preview image is displayed according to a selected format and said content feature is associated with said format.

17. The system according to claim 16, further including a plurality of content features, the type and number of said content features being determined by said selected format.

18. The system according to claim 1, wherein said developer terminal is communicatively connected to said central computer via said communication network.

19. A system for aiding in the development of displayed content, said system comprising:
a user terminal having a first display device;
a central computer;
a communication network, said central computer communicatively connected to said user terminal via said communication network, such that said central computer may cause content to be displayed by said first display device;
a computer readable medium communicatively connected to said central computer, said computer readable medium encoded with content information and content format information;
a developer terminal having a second display device, said developer terminal communicatively connected to said central computer such that said developer terminal may access said content information and said content format information,
wherein said second display device is configured to display:
a preview pane containing a preview image corresponding to an image of said content as it would appear at a current stage of development, said preview image having an area corresponding to a content feature and said preview image being displayed according to a selected format;
a plurality of content features associated with said selected format; and
a development pane containing at least one data input tool corresponding to said plurality of content features,
wherein said data input tool is configured to associate a content piece with said content feature,
wherein said preview pane and said development pane are simultaneously displayed, and
wherein said area of said preview image indicates whether said content piece has been associated with said content feature.

20. A user interface for developing content, said user interface being displayed to a developer on a display device associated with a developer terminal, the user interface comprising:
a data input tool corresponding to a content feature; and
a preview image corresponding to an image of said content as it would appear at a current stage of development, said preview image having an area corresponding to said content feature, wherein
said data input tool is configured to associate a content piece with said content feature, and
said area of said preview image indicates whether said content piece has been associated with said content feature.

21. The user interface according to claim 20, wherein said content piece is one of a text string, a text file, an image, an image file, a video clip, an animated clip and an audio clip.

22. The user interface according to claim 20, wherein said data input tool is one of a pull-down menu, a text bar, and a selectable icon.

23. The user interface according to claim 20, wherein said user interface is configured to retrieve said content piece from a computer readable medium encoded with a plurality of content pieces.

24. The user interface according to claim 23, wherein said plurality of content pieces are organized into groups in a data storage structure.

25. The user interface according to claim 23, wherein said data storage structure is a database and said groups are database records.

26. The user interface according to claim 20, said data input tool further configured to display an available content piece that a developer can selectively associate with said content feature.

27. The user interface according to claim 20, said preview image further including a feature manipulation tool associated with said content feature, said feature manipulation tool configured to allow said developer to change at least one of a size and a location of said content feature.

28. The user interface according to claim 20, wherein said preview image is configured to display said content piece in said area corresponding to said content feature after said content piece has been associated with said content feature by said developer.

29. The user interface according to claim 20, wherein said data input tool is configured to accept a new content piece entered by said developer.

30. The user interface according to claim 29, wherein said user interface is configured to store said new content piece in a computer readable medium encoded with a plurality of content pieces.

31. The user interface according to claim 20, wherein said developer associates said data input tool with said content feature by selecting said area of said preview image.

32. The user interface according to claim 20, wherein said data input tool is displayed within a development pane and said preview image is displayed within a preview pane.

33. The user interface according to claim 20, wherein said data input tool is displayed in a portion of said preview image.

34. The user interface according to claim 20, wherein said area of said preview image indicates whether said content piece has been associated with said content feature by displaying said content piece when said content piece has been associated with said content feature and displaying a data input tool when said content piece has not been associated with said content feature.

35. The user interface according to claim 20, wherein said preview image is displayed according to a selected format and said content feature is associated with said format.

36. The user interface according to claim 35, further including a plurality of content features, the type and number of said content features being determined by said selected format.

37. A graphical user interface for developing content, said graphical user interface being displayed to a developer on a display device associated with a developer terminal, the graphical user interface comprising:
a preview pane containing a preview image corresponding to an image of said content as it would appear at a current stage of development, said preview image having an area corresponding to a content feature and said preview image being displayed according to a selected format;
a plurality of content features associated with said selected format; and
a development pane containing at least one data input tool corresponding to said plurality of content features, wherein
said data input tool is configured to associate a content piece with said content feature,
said preview pane and said development pane are simultaneously displayed, and
said area of said preview image indicates whether said content piece has been associated with said content feature.

38. A method for developing content, said method comprising:
storing a plurality of content pieces in a content piece data storage structure;
storing a plurality of content formats in a format data storage structure, said plurality of content formats each being associated with at least one content feature;
selecting a content format from among said plurality of content formats;
displaying a preview image corresponding to an image of said content at a current stage of development, said preview image being displayed according to said selected content format and having an area for displaying each of said at least one content feature;
simultaneously displaying a data input tool corresponding to said at least one content feature associated with said selected content format;
associating said associated content feature with a content piece from among said plurality of content pieces; and
altering said preview image to indicate that said associated content piece has been associated with said associated content feature.

39. The method according to claim 38, further including entering a new content piece using said data input tool and storing said new content piece in said content piece data storage structure.

40. The method according to claim 38, wherein said selected content format is associated with a plurality of content features, and further including selecting said area of said preview image corresponding to said at least one of said plurality of content features to cause said data input tool to correspond to at least one of said plurality of content features.

41. The method according to claim 38, wherein said selected content format attributes a size to said area of said preview image in which said associated content feature, and further including altering said content piece to be displayed within said area.

42. The method according to claim 38, wherein said preview image is displayed in a preview pane and said data input tool is displayed in a separate development pane.

43. The method according to claim 38, wherein said data input tool is displayed within said preview image.

44. The method according to claim 38, further including storing said content on a computer readable memory associated with said central computer and transmitting said content to a user terminal for display to a user.

45. A method for developing advertising content for a product, said method comprising:
by a developer, selecting a format in which said advertising content is to be displayed;
displaying a preview image of said advertising content in said format, said format corresponding to a content feature that may be associated with one of a plurality of content pieces;
simultaneously displaying a selectable list of said plurality of content pieces;
by said developer, selecting one of said plurality of content pieces;
associating said selected content piece with said content feature; and
displaying said selected content piece in said preview image, wherein
said content feature is one of a product image, product description information, product pricing information, and product availability information.

46. The method according to claim 45, wherein said content feature is a product image and said selected content piece is an image file, and further including accessing a computer readable medium encoded with a plurality of images of said product and retrieving said image file.

47. The method according to claim 45, wherein said selected content piece is a selected text file describing one of a feature of said product, a price of said product or availability of said product, and further including accessing a computer readable medium encoded with a plurality of text files and retrieving said selected text file.

48. The method according to claim 45, further including storing said advertisement content on a computer readable medium after said content piece has been associated with said content feature.

49. The method according to claim 45, wherein said preview image is displayed in a preview pane and said selectable list is displayed in a separate development pane.
